(19) United States
(12) Patent Application Publication
(10) Pub. No.: US 2008/0175391 A1
(43) Pub. Date: Jul. 24, 2008

(54) APPARATUS AND METHOD FOR CRYPTOGRAPHIC PROTECTION OF DIRECTORIES AND FILES

(75) Inventors: David FINKELSTEIN, Sunnyvale, CA (US); William F. PRICE, Los Altos, CA (US); Derek ATKINS, Somerville, MA (US); Harold FINNEY, Santa Barbara, CA (US)

Correspondence Address: COOLEY GODWARD KRONISH LLP;ATTN: Patent Group, Suite 1100, 777 - 6th Street, NW, Washington, DC, 20001, US

(73) Assignee: PGP CORPORATION, Palo Alto, CA (US)

(21) Appl. No.: 11/863,165

(22) Filed: Sep. 27, 2007

Related U.S. Application Data
(60) Provisional application No. 60/827,412, filed on Sep. 28, 2006.

(51) Int. Cl. H04L 9/08; H04L 9/30; G06F 12/14

(52) U.S. Cl. 380/278; 713/165; 380/44; 380/30

(57) ABSTRACT

A computer readable storage medium includes executable instructions to encrypt a file with a file encryption key to produce an encrypted file. The file encryption key is encrypted with a directory encryption key to produce an encrypted file encryption key. The directory encryption key is encrypted with a public key of a user within a group to produce an encrypted directory encryption key.

### BRIEF DESCRIPTION OF THE INVENTION

This invention relates generally to the processing of digital data. More particularly, this invention relates to the cryptographic protection of data in directories and files.

### BACKGROUND OF THE INVENTION

Without strong data protection, sensitive data is at risk of corporate espionage, accidental loss, or casual theft. Sensitive data landing in the wrong hands can result in significant financial loss, legal ramifications, and brand damage.

Thus, it would be desirable to provide an easily invoked and executed data protection scheme.

### SUMMARY OF THE INVENTION

The invention includes a computer readable storage medium with executable instructions to encrypt a file with a file encryption key to produce an encrypted file. The file encryption key is encrypted with a directory encryption key to produce an encrypted file encryption key. The directory encryption key is encrypted with a public key of a user within a group to produce an encrypted directory encryption key.

A symmetrical decryption operation may then be performed. The encrypted directory encryption key is decrypted with a private key of the user within the group to produce the directory encryption key. The encrypted file encryption key is decrypted with the directory encryption key to produce the file encryption key. The encrypted file is decrypted with the file encryption key to produce the file.

The invention also includes a computer readable storage medium with executable instructions to generate a directory encryption key, generate file encryption keys for each file in a directory, select a file encryption key for each file in the directory, and encrypt each file in the directory with a file encryption key. Each file encryption key is encrypted with the directory encryption key. The directory encryption key is encrypted with a public key.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIGS. 3-6 illustrate Graphical User Interfaces (GUIs) utilized in accordance with embodiments of the invention.

FIG. 7 illustrates encryption processing operations associated with an embodiment of the invention.

FIG. 8 illustrates decryption processing operations associated with an embodiment of the invention.

FIG. 9 illustrates encryption and decryption operations performed in accordance with an embodiment of the invention.

Like reference numerals refer to corresponding parts throughout the several views of the drawings.

### DETAILED DESCRIPTION OF THE INVENTION

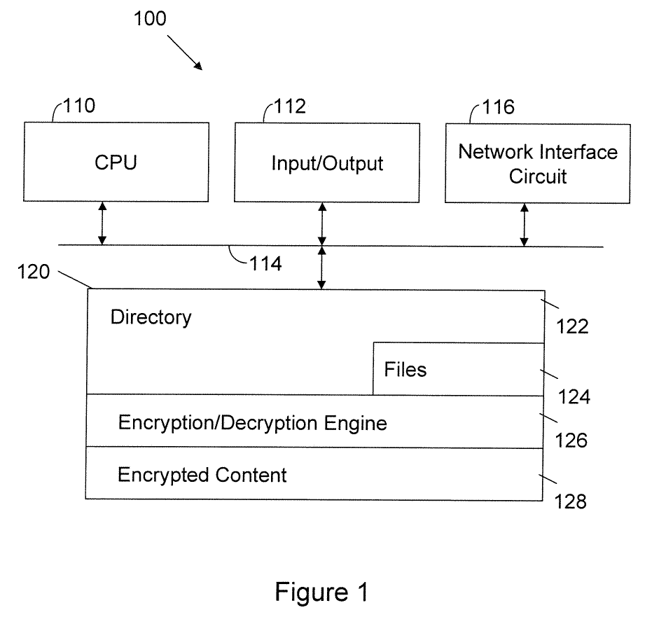

FIG. 1 illustrates a computer 100 configured in accordance with an embodiment of the invention. The computer 100 includes standard components, such as a central processing unit (CPU) 110 and input/output devices 112 connected via a bus 114. The input/output devices 112 may include a keyboard, mouse, monitor, printer and the like. A network interface circuit 116 is also connected to the bus 114 to provide connectivity to a network (not shown).

A memory 120 is also connected to the bus 114. The memory 120 includes at least one directory with a set of files 124. The directory and files are cryptographically protected in accordance with an embodiment of the invention. In particular, an encryption/decryption engine 126 includes executable instructions to implement cryptographic protection operations disclosed herein. The processing performed by the encryption/decryption engine 126 results in encrypted content 128.

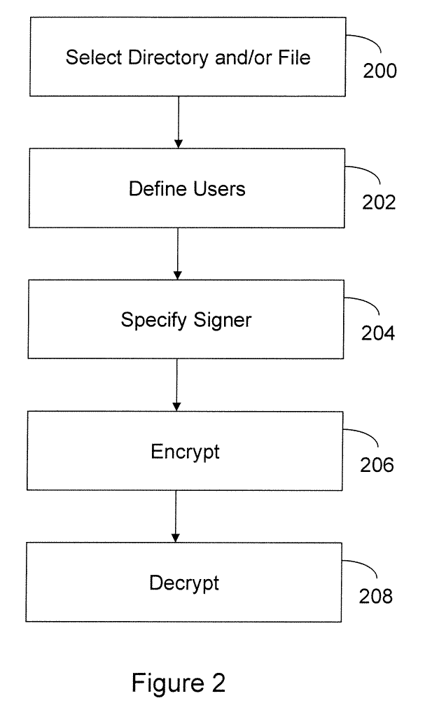

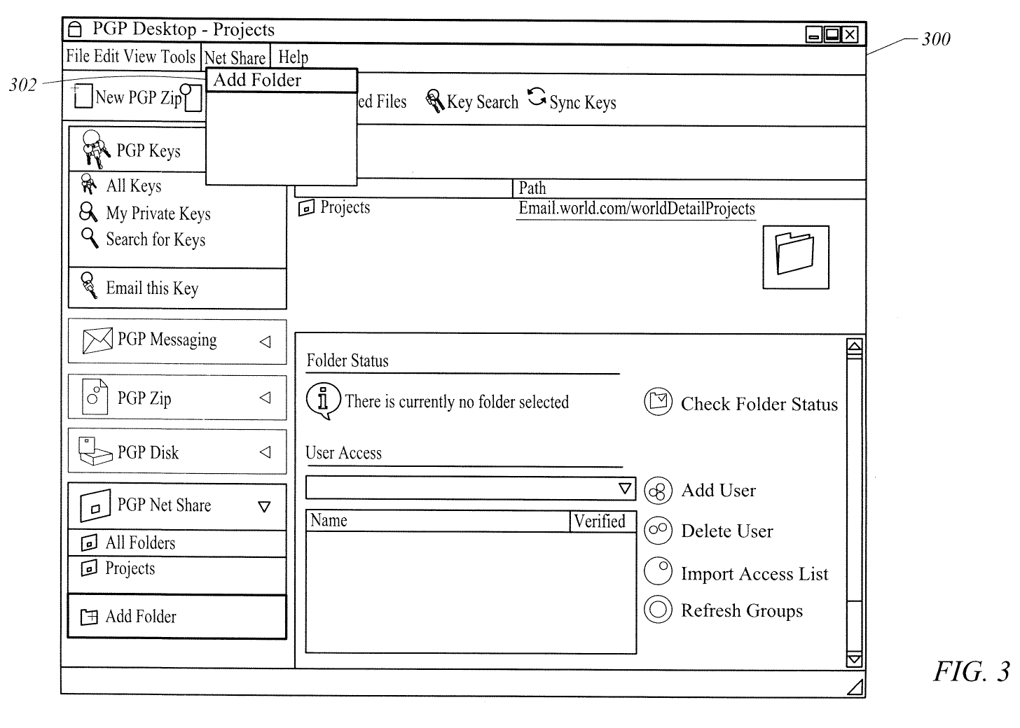

FIG. 2 illustrates processing operations supported by the encryption/decryption engine 126. The encryption/decryption engine 126 provides a graphical user interface (GUI) to allow a user to select a directory and/or a file 200 to be protected. FIG. 3 illustrates an exemplary interface 300 to support this operation. Pull-down window 302 allows one to specify a folder 302 (e.g., a directory). The folder has an associated set of files.

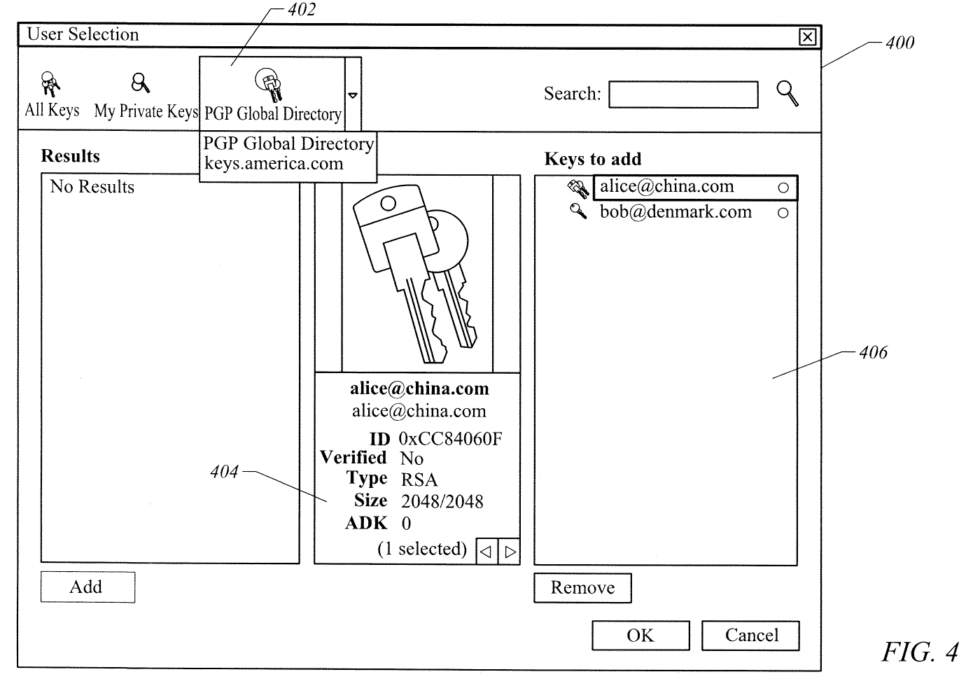

The next processing operation of FIG. 2 is to define users 202 that can access the folder. FIG. 4 illustrates a GUI 400 that allows one to specify users that have access to the folder and the files therein. Pull-down window 402 allows one to specify a directory of users. Individual users may be identified and selected in window 404. Cryptographic keys associated with the users are then added to window 406.

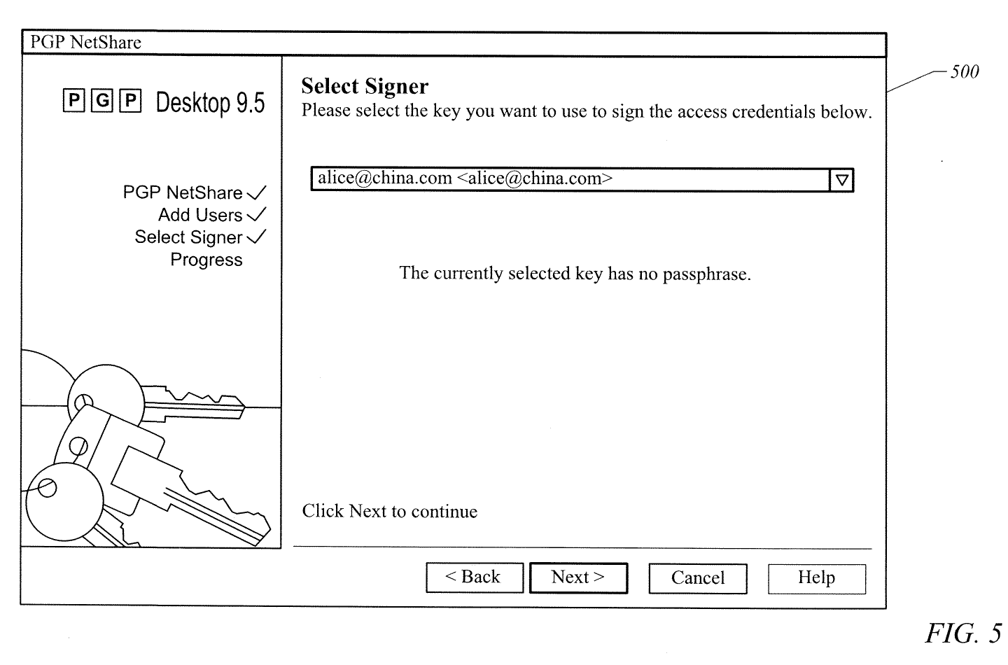

The next processing operation of FIG. 2 is to specify a signer 204. The specified signer is used to sign access credentials. A key pair for the signer may be selected. Preferably, a pass phrase is also used to specify the signer. FIG. 5 illustrates a GUI 500 that may be used to specify a signer.

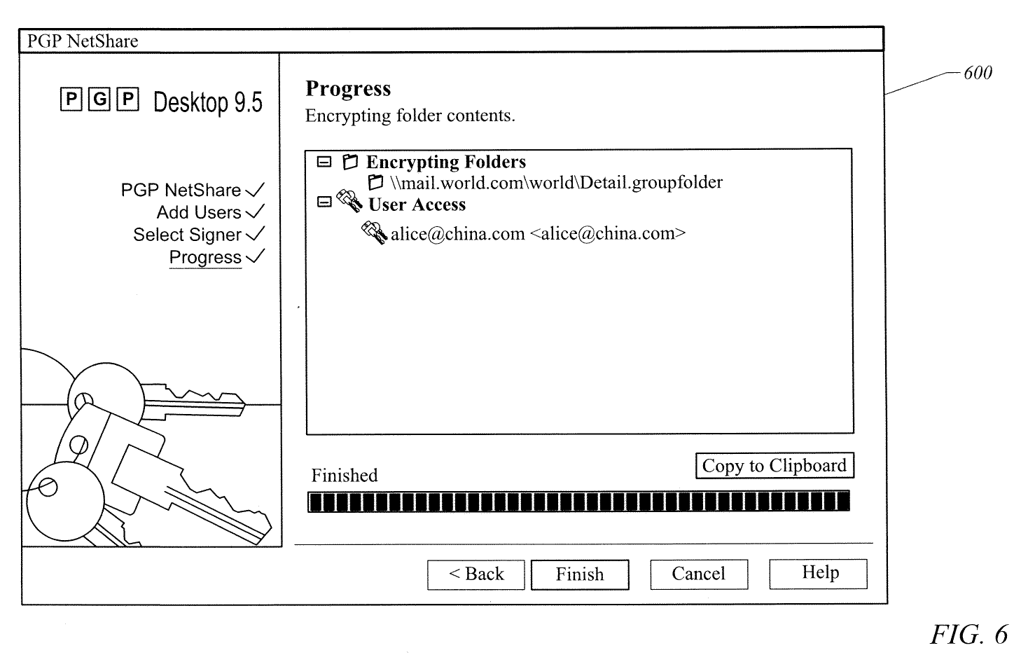

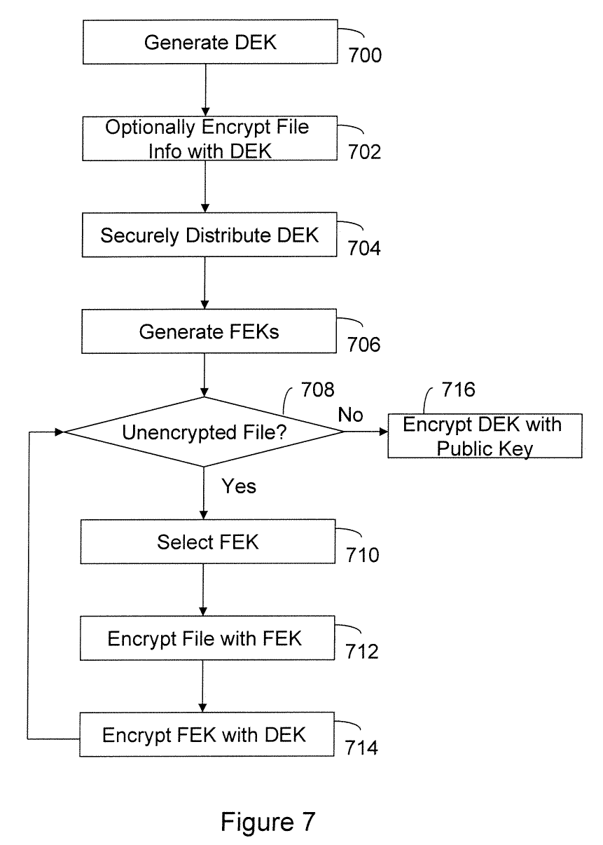

The next operation of FIG. 2 is to encrypt the files and directory associated with the folder 206. FIG. 6 illustrates a GUI 600 reflecting the process of this operation. The process underlying this operation is discussed in connection with FIG. 7.

FIG. 7 illustrates encryption operations performed by the encryption/decryption engine 126. Initially, a directory encryption key (DEK) is generated (e.g., a symmetric key). Optionally, file information, such as file name and file size, may be encrypted with the DEK. This prevents a user from deriving file information unless the user has a DEK. The encryption operation may be accompanied by other operations, such as padding each file size to a uniform length to protect file information.

The next operation of FIG. 7 is to securely distribute the DEK to the users associated with the directory or folder. Recall that these users were defined in operation 202 of FIG. 2. In one embodiment the DEK is encrypted with a key that is common to each user within the group. Alternately, each public key for each user may be used as the DEK, although this approach does not scale well.

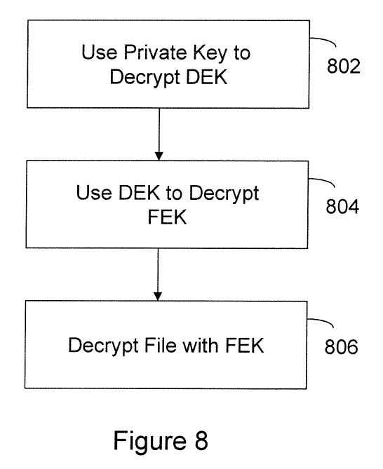

The next operation of FIG. 7 is to generate file encryption keys (FEKs) for each file in the folder. The FEKS may be symmetric keys. If there is an unencrypted file in the folder (708—YES), then a FEK is selected 710. A folder is then encrypted with the selected FEK 712. The selected FEK is then encrypted with the DEK 714 and control returns to block 708. The process of blocks 708-714 is repeated until each file is encrypted with a FEK and each FEK is encrypted with the DEK. Where there are no more unencrypted files (708—NO), the DEK is encrypted with a public key of a user within the group 716. At this point, all files in the directory are encrypted. Similarly, each FEK is encrypted, as is the DEK. Thus, the data is securely protected. To access the secure data, the operations of FIG. 8 are performed.

FIG. 8 illustrates the decrypt operation 208 of FIG. 2. The decrypt operations are performed by the encryption/decryption engine 126. The decrypt operation is initiated by invoking a user private key to decrypt the DEK 802. The decrypted DEK is then used to decrypt a FEK 804. The decrypted FEK is then used to decrypt the file 806. This yields the original data file. These operations may be repeated for other specified files in the directory. The encryption/decryption engine 126 automatically performs these operations when a validated user within the specified group requests a file.

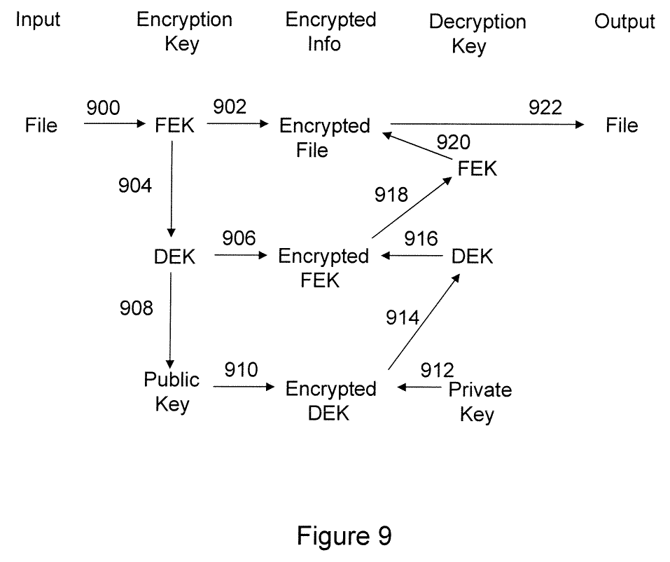

FIG. 9 illustrates operations associated with the invention. In particular, the figure illustrates which encryption keys are used to produce which encrypted information. Similarly, the figure illustrates which decryption keys are used to decrypt the encrypted information. As shown with arrow 900, an unprotected file is processed with a FEK to produce an encrypted file, as shown with arrow 902. The FEK is then processed with a DEK, as shown with arrow 904 to produce an encrypted FEK, as shown with arrow 906. The DEK is then processed with a public key of user in the group, as shown with arrow 908. This produces an encrypted DEK, as shown with arrow 910. Thus, a FEK, DEK and public key have been used as encryption keys to respectively produce an encrypted file, an encrypted FEK and an encrypted DEK.

To access the encrypted file, a private key of a user is invoked to decrypt the DEK, as shown with arrow 912. This produces a DEK, as shown with arrow 914. The DEK is then used to process the encrypted FEK, as shown with arrow 916, which produces the FEK, as shown with arrow 918. The FEK is then applied to the encrypted file, as shown with arrow 920. This produces the original, unencrypted file, as shown with arrow 922.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
encrypt a file with a file encryption key to produce an encrypted file;
encrypt the file encryption key with a directory encryption key to produce an encrypted file encryption key; and
encrypt the directory encryption key with a public key of a user within a group to produce an encrypted directory encryption key.

2. The computer readable storage medium of claim 1 further comprising executable instructions to:
decrypt the encrypted directory encryption key with a private key of the user within the group to produce the directory encryption key.

3. The computer readable storage medium of claim 2 further comprising executable instructions to:
decrypt the encrypted file encryption key with the directory encryption key to produce the file encryption key.

4. The computer readable storage medium of claim 3 further comprising executable instructions to:
decrypt the encrypted file with the file encryption key to produce the file.

5. The computer readable storage medium of claim 1 wherein the file encryption key is a symmetric key.

6. The computer readable storage medium of claim 1 wherein the directory encryption key is a symmetric key.

7. The computer readable storage medium of claim 1 further comprising executable instructions to securely distribute the directory encryption key to a user within the group of users.

8. The computer readable storage medium of claim 7 further comprising executable instructions to encrypt the directory encryption key with a key common to each user within the group.

9. The computer readable storage medium of claim 1 further comprising executable instructions to encrypt file information with the directory encryption key.

10. A computer readable storage medium, comprising executable instructions to:
generate a directory encryption key;
generate file encryption keys for each file in a directory;
select a file encryption key for each file in the directory;
encrypt each file in the directory with a file encryption key;
encrypt each file encryption key with the directory encryption key; and
encrypt the directory encryption key with a public key.

11. The computer readable storage medium of claim 10 further comprising executable instructions to use a private key to decrypt the directory encryption key.

12. The computer readable storage medium of claim 11 further comprising executable instructions to use the directory encryption key to decrypt a file encryption key.

13. The computer readable storage medium of claim 12 further comprising executable instructions to decrypt a file with the file encryption key.

14. The computer readable storage medium of claim 10 further comprising executable instructions to securely distribute the directory encryption key to a user within a group.

15. The computer readable storage medium of claim 14 further comprising executable instructions to encrypt the directory encryption key with a key common to each user within the group.

16. The computer readable storage medium of claim 15 further comprising executable instructions to encrypt file information with the directory encryption key.

17. The computer readable storage medium of claim 10 wherein the file encryption key is a symmetric key.

18. The computer readable storage medium of claim 10 wherein the directory encryption key is a symmetric key.
